(19) United States
(12) Patent Application Publication
(10) Pub. No.: US 2025/0056339 A1
(43) Pub. Date: Feb. 13, 2025

(54) METHODS, DEVICES, APPARATUSES AND MEDIUM FOR MEASUREMENT-BASED TCI STATE ACTIVATION

(71) Applicant: Nokia Technologies Oy, Espoo (FI)

(72) Inventors: Riikka Karoliina DIMNIK, Espoo (FI); Jani-Pekka KAINULAINEN, Cambridge (GB); Lars DALSGAARD, Oulu (FI)

(21) Appl. No.: 18/782,537

(22) Filed: Jul. 24, 2024

Related U.S. Application Data
(60) Provisional application No. 63/518,800, filed on Aug. 10, 2023.

(51) Int. Cl. H04W 36/00; H04W 36/08

(52) U.S. Cl. CPC H04W 36/0072; H04W 36/0085; H04W 36/08

(57) ABSTRACT

Embodiments of the present disclosure relate to apparatuses, methods, devices and computer readable storage medium for TCI state activation, comprising: at a first apparatus, receiving, from a second apparatus, a layer 3 measurement for a cell for a layer 1/layer 2 triggered mobility operation; determining that at least one condition of transmission configuration indicator (TCI) state activation for the cell is met; based on the determining that the at least one condition of TCI state activation for the cell is met, determining, based at least in part on the layer 3 measurement for the cell, that at least one TCI state for the cell is to be activated; and based on the determining that the at least one TCI state for the cell is to be activated, transmitting, to the second apparatus, an indication of activation of the at least one TCI state for the cell.

### CROSS-REFERENCE TO RELATED APPLICATION

This application claims priority to, and the benefit of, U.S. Provisional Application No. 63/518,800, filed Aug. 10, 2023, the contents of which are hereby incorporated by reference in their entirety.

### FIELDS

Various example embodiments of the present disclosure generally relate to the field of telecommunication and in particular, to methods, devices, apparatuses and computer readable storage medium for measurement-based transmission configuration indication (TCI) state activation.

### BACKGROUND

Layer 1/layer 2 (L1/L2) triggered mobility (LTM) is a procedure in where the terminal device is changing serving cells based on L1/L2 triggered command. The terminal device is configured with one or more candidate cells with radio resource control (RRC) configuration. In LTM, the network device receives L1 measurement reports from terminal devices, and the network device decides and requests changes on serving cell(s) of the terminal devices by a cell switch command (e.g., MAC control element, for example, MAC CE). The MAC CE is used to indicate configured LTM candidate cell (e.g., cell id), is to be used as target for a cell switch, hence, indicating a LTM handover. The network device may activate or indicate a (unified) TCI state of a cell in the LTM procedure.

### SUMMARY

In a first aspect of the present disclosure, there is provided a first apparatus. The first apparatus comprises at least one processor; and at least one memory storing instructions that, when executed by the at least one processor, cause the first apparatus at least to perform: receiving, from a second apparatus, a layer 3, L3 measurement for a cell for a layer 1/layer 2, L1/L2, triggered mobility operation; determining that at least one condition of transmission configuration indicator, TCI, state activation for the cell is met; based on the determining that the at least one condition of TCI state activation for the cell is met, determining, based at least in part on the L3 measurement for the cell, that at least one TCI state for the cell is to be activated; and based on the determining that the at least one TCI state for the cell is to be activated, transmitting, to the second apparatus, an indication of activation of the at least one TCI state for the cell.

In a second aspect of the present disclosure, there is provided a second apparatus. The second apparatus comprises at least one processor; and at least one memory storing instructions that, when executed by the at least one processor, cause the second apparatus at least to perform: transmitting, to a first apparatus, a layer 3, L3 measurement for a cell for a layer 1/layer 2, L1/L2, triggered mobility operation; and receiving, from the first apparatus, an indication of activation of at least one transmission configuration indicator, TCI, state for the cell, wherein the activation of the at least one TCI state is determined based at least in part on the L3 measurement for the cell.

In a third aspect of the present disclosure, there is provided a method. The method comprises: receiving, from a second apparatus, a layer 3, L3 measurement for a cell for a layer 1/layer 2, L1/L2, triggered mobility operation; determining that at least one condition of transmission configuration indicator, TCI, state activation for the cell is met; based on the determining that the at least one condition of TCI state activation for the cell is met, determining, based at least in part on the L3 measurement for the cell, that at least one TCI state for the cell is to be activated; and based on the determining that the at least one TCI state for the cell is to be activated, transmitting, to the second apparatus, an indication of activation of the at least one TCI state for the cell.

In a fourth aspect of the present disclosure, there is provided a method. The method comprises: transmitting, to a first apparatus, a layer 3, L3 measurement for a cell for a layer 1/layer 2, L1/L2, triggered mobility operation; and receiving, from the first apparatus, an indication of activation of at least one transmission configuration indicator, TCI, state for the cell, wherein the activation of the at least one TCI state is determined based at least in part on the L3 measurement for the cell.

In a fifth aspect of the present disclosure, there is provided a first apparatus. The first apparatus comprises means for receiving, from a second apparatus, a layer 3, L3 measurement for a cell for a layer 1/layer 2, L1/L2, triggered mobility operation; means for determining that at least one condition of transmission configuration indicator, TCI, state activation for the cell is met; means for, based on the determining that the at least one condition of TCI state activation for the cell is met, determining, based at least in part on the L3 measurement for the cell, that at least one TCI state for the cell is to be activated; and means for, based on the determining that the at least one TCI state for the cell is to be activated, transmitting, to the second apparatus, an indication of activation of the at least one TCI state for the cell.

In a sixth aspect of the present disclosure, there is provided a second apparatus. The second apparatus comprises means for transmitting, to a first apparatus, a layer 3, L3 measurement for a cell for a layer 1/layer 2, L1/L2, triggered mobility operation; and means for receiving, from the first apparatus, an indication of activation of at least one transmission configuration indicator, TCI, state for the cell, wherein the activation of the at least one TCI state is determined based at least in part on the L3 measurement for the cell.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart illustrating an example of measurement-based TCI state activation according to some example embodiments of the present disclosure;

FIG. 3 illustrates a flowchart of TCI state activation/indication based on L3 measurement according to some example embodiments of the present disclosure;

FIG. 4 illustrates examples of known TCI state activation based on L3 measurement according to some example embodiments of the present disclosure;

FIG. 5 illustrates examples of unknown TCI state activation based on L3 measurement according to some example embodiments of the present disclosure;

FIG. 6 illustrates another examples of unknown TCI state activation based on L3 measurement according to some example embodiments of the present disclosure;

FIG. 7 illustrates another examples of known TCI state activation based on L3 measurement according to some example embodiments of the present disclosure;

FIG. 8 illustrates a flowchart of a method implemented at a network device according to some example embodiments of the present disclosure;

FIG. 9 illustrates a flowchart of a method implemented at a terminal device according to some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

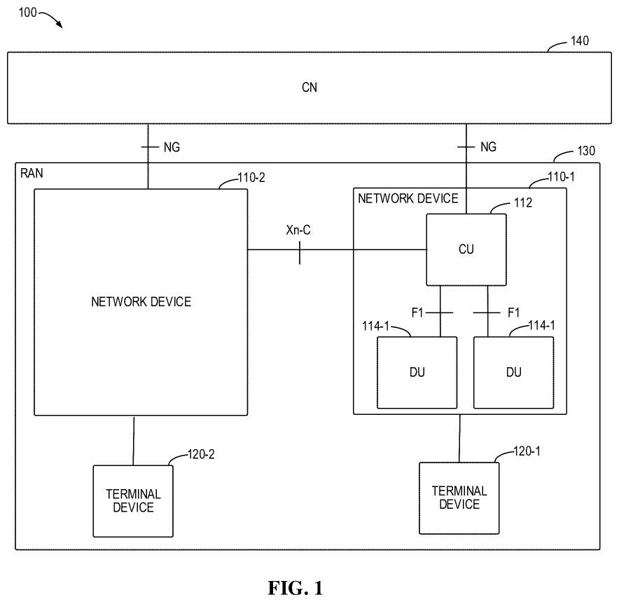

FIG. 1 illustrates an example communication environment 100 in which example embodiments of the present disclosure can be implemented. In the communication environment 100, one or more network devices 110-1, 110-2, and so on (collectively or individually referred to as network devices 110) and one or more terminal devices 120-1, 120-2, and so on (collectively or individually referred to as terminal devices 120) may operate in a radio access network (RAN) 130. The terminal devices 110 may connect with the network device 120 to access the RAN 130. The network devices 110 may communicate with each other, e.g., via Xn-C interface. The network devices 110 may access to a core network (CN) 140, e.g., via NG interface. In some example embodiments, functionalities of a network device 110 (e.g., the network device 110-1) is divided into a central unit (CU) 112, and one or more distributed units (DUs) 114-1, 114-2, and so on (collectively or individually referred to as DUs 114). The CU 112 is configured for operations related to other network device and the CN 140, and the DUs 114 are configured for operations related to the terminal devices. The CU 112 and the DUs 114 may communicate with each other, e.g., via F1 interface.

In some example embodiments, a link from the network device 110 to the terminal device 120 is referred to as a downlink (DL), and a link from the terminal device 120 to the network device 110 is referred to as an uplink (UL). In DL, the network device 110 is a transmitting (TX) device (or a transmitter) and the terminal device 120 is a receiving (RX) device (or a receiver). In UL, the terminal device 120 is a TX device (or a transmitter) and the network device 110 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It would be appreciated that the number of devices and their connections in FIG. 1 are illustrated as an example, and there will be more devices and different connections in the communication environment.

A radio protocol stack may comprise three layers, Layer 1 (L1), Layer 2 (L2), and Layer 3 (L3). To further enhance mobility in communication systems, mechanisms and procedures of L1/L2 triggered mobility (LTM) are specified for mobility latency reduction. Main difference between existing mobility and LTM based mobility is that existing (L3) mobility has its foundation in L3 measurements and L3 measurement reporting (which is based on RRC message) while LTM aims at using other means than RRC signaling for measurement reporting (to reduce latency). Additionally, in order to reduce handover (HO) latency, the goal is to change the actual cell switch (Handover) from being an L3 command using RRC signaling to use other means than RRC signaling (LTM switch command)—currently MAC message is under consideration.

LTM is a procedure in where the UE is changing serving cells based on L1/L2 triggered command. The UE is configured with one or more candidate cells with RRC configuration. In LTM, the network receives L1 measurement reports from UEs, and network decides and requests changes on UEs' serving cell(s) by a cell switch command (e.g., MAC control element, MAC CE). The MAC CE is used to indicate configured LTM candidate cell (e.g., cell id), is to be used as target for a cell switch, hence, indicating a LTM HO.

L3 measurements may be assumed to be performed in parallel with any LTM related measurements. It is assumed that the UE performs intra-frequency and possibly inter-frequency measurements as required.

The cell switch is triggered, by selecting by for example one of the LTM candidate cell configurations as the target configuration by the gNB. An LTM candidate cell configuration can only be added, modified and released by network via RRC signaling.

LTM supports both intra-gNB-DU and intra-gNB-CU inter-gNB-DU mobility. LTM also supports inter-frequency mobility, including mobility to inter-frequency cell that is not a current serving cell.

LTM currently applies for UEs in NR connected mode. However, the procedure may also apply to other states and system like 6G in the future. The current design of the LTM procedure based on latest agreements can be summarized in the following steps:

Step 1. A LTM capable UE is connected to a cell (serving cell) and is performing L3 measurements on one or more neighboring cells.

Step 2. Network provides to the UE through RRC message a LTM candidate cell configuration comprising of one or multiple LTM candidate cells.
LTM Candidate cell configuration can be a reference configuration or delta configuration on top of the reference configuration.

Step 3. UE performs L1 measurements on one or more of the configured candidate cells and reports the results to the network.

Step 4. Based on the UE reported L1 measurement results, the network may configure the UE to activate one or more TCI states with MAC CE for one or more candidate cells. Unified TCI state framework is used in LTM. Related to the target cell TCI control there are at least two options:
TCI state(s) is activated before the LTM cell switch command with a separate MAC-CE.
Alternatively, TCI state activation may be done at the cell switch command (step 5)

Step 5. From the one or more activated LTM candidate cells, the network may select one of the LTM candidate cells as the target cell and request the UE to switch to this cell by sending a MAC-CE LTM cell switch command to have the UE to execute the LTM handover to the target cell.
The cell switch command comprises (at least) of the following:
   The index of LTM candidate target configuration to apply for LTM cell switch;
   Indication (and possibly activation if not done before the cell switch as in step 4) DL and UL (or joint) TCI state ID for the LTM target cell;
   DL and UL bandwidth part (BWP) ID.

Step 6. The UE detaches from the source cell and LTM handover is completed to the target cell.

As an additional or optional step, the network may request the UE to prepare UL synchronization to the potential LTM target cell. This step may be executed between steps 4 and 5 above.

To prepare one or multiple LTM candidate cells, the network may initiate physical downlink control channel (PDCCH) ordered random access on one or multiple candidate cells before the network request the actual TLM cell switch to the target cell(s).

On the potential LTM target cell, using random access channel (RACH), the UE may send preamble to enable network to acquire the UL timing, timing advance (TA) value, of the target cell before the cell switch command.

However, UL synchronization may also be executed after the TLM cell switch, for example if early TA acquisition has not been performed by PDCCH order before the cell switch command.

In NR, reference signal received power (RSRP) measurements are performed and reported at Layer 1 (e.g., physical layer) and Layer 3 (e.g., RRC layer). Measurements can be SSB based or, if configured in CSI-MeasConfig, also CSI-RS based.

L3 measurements are cell or beam level measurements. Beam level measurements are generated from the L1 measurements by applying L3 filtering. Cell level measurements are derived from the L1 measurements using certain rules. L3 RSRP measurements are reported in RRC measurement report in MeasResults information element.

L1 measurements are beam level measurements. L1 RSRP measurements are reported by the UE at channel state information (CSI) based on CSI-ReportConfig.

For LTM measurements, the UE may be configured to measure candidate cells for LTM handover purposes, which can be:
Current serving cells
Neighbour cells

When the UE receives the candidate cell configuration from the network, the UE starts/continues performing L3 measurements on these cells.

LTM cell switch decision is done based on L1 measurements. It has been discussed an option to perform LTM handover based on L3 measurements, as stated in below Table 1. This is because the UE may have limitations on how many neighboring cells it may perform L1 measurements, and therefore the UE is able to perform L1 measurements only on a subset of candidate cells, which limits the candidate cell selection to these cells.

TABLE 1
Issue 2-2-1: Whether to use final L3 measurement results for L1 measurement report
<Agreement>
Baseline: UE is NOT expected to use L3 measurement results for intra-frequency
or inter-frequency L1 measurement report.
UE shall support L1 measurements for at least [2 or 3] neighboring cells.
Introduce optional UE support to use L3 measurement results for intra-frequency
or inter-frequency L1 measurement report.
Note 1: No impact on RAN1/2 design is expected.
Note 2: the principles of the solution need to be agreed in RAN4 #108
meetings and the mechanism can be removed if no consensus reached on
solution.

L1 measurement report is sent to DU (distributed unit), while L3 measurement report is sent to CU (centralized unit). LTM cell switch decision is made by DU. Therefore, to be able to use L3 measurements for LTM target cell selection by the DU, it has been proposed in RAN4 (e.g., by Nokia) that the UE could include L3 measurements in L1 report to enable reporting L3 measurements to the DU and consequently, target cell selection based on L3 measurements.

Taking into account the above, the UE may report to the network:
L3 measurement results in L3 measurement report (reported to CU);
L1 measurement results in L1 measurement report (reported to DU);
L3 measurement results in L1 measurement report (reported to DU, not standardized yet).

The unified TCI state framework was specified by the 3GPP in Rel-17. In Rel-15/16, TCI states were only configured for downlink, while uplink spatial relation covered the beam indication for uplink. With the unified TCI state concept, TCI states are configured for both downlink and uplink. The configuration is either joint, where same TCI state covers both UL and DL, or separate, where there are separate TCI states configured for DL and UL.

The unified TCI state framework uses a common TCI state concept, where one common TCI/indicated TCI state at a time provides spatial assumption for the set of signals and channels (PDCCH, PDSCH, PUCCH, PUSCH, CSI-RS, and/or SRS).

Configuration and control of the unified TCI states is done with the following steps:
Step 1. RRC-based configuration of up to 128 TCI states.
Step 2. MAC-CE-based activation of up to 16 UL or DL TCI states or 8 joint TCI states into 8 codepoints.
   If only one joint UL/DL TCI state or a single pair of UL and DL TCI state is activated, this will become also the indicated TCI state, and step 3 is not needed.
   In LTM, the activation may be done in a separate MAC CE before the cell switch command or in the cell switch command.
Step 3. DCI-based indication of a single joint TCI state or TCI state pair of DL and UL TCI states.
   In LTM, the indication is done in the cell switch command, which is a MAC CE.

RAN4 has defined TCI state switch requirements for unified TCI states for DL in section 8.15 and for UL in section 8.16 in TS 38.133. Delay requirements are defined for:
MAC-CE based on downlink/uplink TCI state switch (activation of one joint or one pair of DL/UL TCI states).
DCI-based downlink/uplink TCI state switch (indication of one TCI state on the active TCI state list).
DL/UL active TCI state list update (activation of more than one TCI state).

The requirements are defined for known and for some cases also unknown TCI states. The definition of known TCI state is the following for downlink TCI states in Table 2:

TABLE 2
8.15.2 Known conditions for downlink TCI state
The downlink TCI state is known if the following conditions are met:
During the period from the last transmission of the RS resource used for the L1-
RSRP measurement reporting for the target downlink TCI state to the
completion of active downlink TCI state switch, where the RS resource for L1-
RSRP measurement is the RS in target downlink TCI state or QCLed to the
target downlink TCI state
Downlink TCI state switch command is received within 1280 ms upon the
last transmission of the RS resource for beam reporting or measurement;
The UE has sent at least 1 L1-RSRP report for the target downlink TCI
state before the downlink TCI state switch command;
The target downlink TCI state remains detectable during the downlink
TCI state switching period;
The SSB associated with the downlink TCI state remain detectable during
the downlink TCI switching period;
SNR of the downlink TCI state ≥−3 dB;
The SSB can be associated with either the serving cell PCI or a PCI
different from serving cell PCI.
Otherwise, the downlink TCI state is unknown.

The TCI state switching delay requirements for unified DL and UL TCI states can be found in sections 8.15 and 8.16 of TS 38.133, respectively.

In the delay requirements (MAC-CE based TCI state switch or active TCI state list update), when a TCI state to be activated/indicated is unknown, an additional delay of T_L1-RSRP is included in the delay for FR2 when Quasi Co-Located (QCL) Type D is involved. For example, for MAC-CE based downlink TCI state switch for unified TCI state:

### Known TCI State:

If the target TCI state is known, upon receiving PDSCH carrying MAC-CE activation command in slot n, UE shall be able to receive UE-dedicated PDCCH/PDSCH with target TCI state of the serving cell on which TCI state switch occurs at the first slot that is after slot n+T_{HARQ}+3Nₛₗₒₜ^{subframe,μ}1+TOₖ*(T_{first-SSB}+T_{SSB-pro})/NR slot length.

### Unknown TCI State:

If the target TCI state is unknown, upon receiving PDSCH carrying MAC-CE activation command in slot n, UE shall be able to receive UE-dedicated PDCCH/PDSCH with target TCI state of the serving cell on which TCI state switch occurs at the first slot that is after slot n+T_{HARQ}+3Nₛₗₒₜ^{subframe,μ}+(T_{L1-RSRP}+TOᵤₖ*(T_{first-SSB}+T_{SSB-proc})/NR slot length.

For the network to be able to activate a (unified) TCI state, the UE has to have performed and reported L1 measurements for the RS (reference signals) on the beam in question. Based on this definition, the network can only activate a TCI state with a QCL relation to a certain RS when it has received related L1 measurement results from the UE in a measurement report.

TCI state activation and indication are part of the LTM procedure, activation being done either before or at the cell switch command and indication being done at the cell switch command. This works nicely if the LTM cell switch decision is done based on L1 measurements. However, when the aim is to allow LTM cell switch decision to be made based on L3 measurements (reported in L1 measurement report or L3 measurement report), the network will not be able to activate a TCI state for the target cell/beam with the current definition, because L1 measurement is needed before the TCI state can be activated.

According to some example embodiments of the present disclosure, there is provided a solution for measurement-based TCI state activation. In this solution, a first apparatus may receive, from a second apparatus, a L3 measurement for a cell for a L1/L2 triggered mobility operation. The first apparatus may determine whether at least one condition of transmission configuration indicator, TCI, state activation for the cell is met. Based on the determining that the at least one condition of TCI state activation for the cell is met, the first apparatus determines, based at least in part on the L3 measurement for the cell, that at least one TCI state for the cell is to be activated. The first apparatus may, based on the determining that the at least one TCI state for the cell is to be activated, transmit, to the second apparatus, an indication of activation of the at least one TCI state for the cell.

Example embodiments of the present disclosure will be described in detail below with reference to the accompanying drawings.

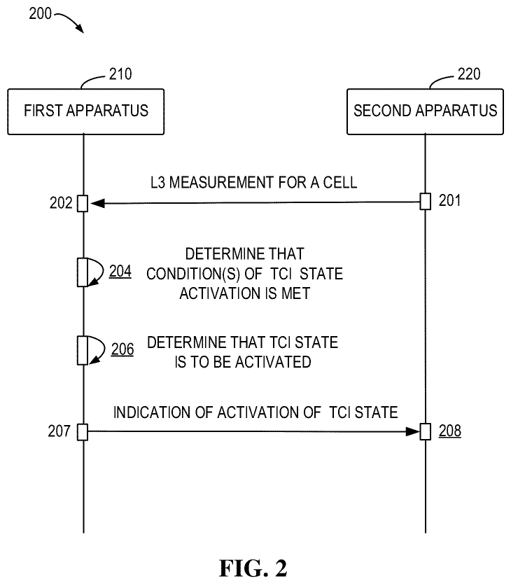

Reference is now made to FIG. 2, which illustrates a signaling chart 200 for measurement-based TCI state activation according to some example embodiments of the present disclosure. As shown in FIG. 2, the signaling chart 200 involves the first apparatus 210 and the second apparatus 220. For the purpose of discussion, reference is made to FIG. 1 to describe the signaling chart 200. In some example embodiments, the first apparatus 210 may be a network device 110 in FIG. 1, and the second apparatus 220 may be a network device 120 in FIG. 1.

In the signaling flow 200, a second apparatus 220 transmits (201) L3 measurement for a cell to the first apparatus 210. Then, the first apparatus 210 receives (202) the L3 measurement for a L1/L2 triggered mobility (LTM) operation.

Based on the reception of the L3 measurement from the second apparatus 220, the first apparatus 210 determines whether at least one condition of TCI state activation for the cell is met. Based on the determining (204) that the at least one condition of TCI state activation for the cell is met, the first apparatus 210 determines, based at least in part on the L3 measurement for the cell, whether at least one TCI state for the cell is to be activated. This cell may be referred to as a LTM candidate cell.

Based on the determining (206) that the at least one TCI state for the cell is to be activated, the first apparatus 210 transmits (207) an indication of activation of the at least one TCI state for the cell. Correspondingly, the second apparatus 220 receives (208) the indication of activation of the at least one TCI state from the first apparatus 210.

When receiving the LTM candidate cell configuration, the second apparatus 220 (e.g., the terminal device) may have already performed (and reported) L3 measurements for one or more of the LTM candidate cells in the configuration. Based on the LTM configuration, the second apparatus 220 will start/continue to perform further L3 and/or L1 measurements on the LTM candidate cells it has detected and report the measurement results to the network. In some cases, the second apparatus 220 may only be able to perform L1 measurements on a subset of the cells. Therefore, the first apparatus 210 may receive and have available from the UE for each cell one or more of L1 measurement reports containing L1 measurement results and/or L3 measurement results, and L3 measurement reports containing L3 measurement results. According to example embodiments, it allows TCI state activation based on the reported L3 measurement results reported in the L1 measurement report because these are sent to the DU, but some other example embodiments can also be applicable when L3 measurements are reported normally in L3 measurement report to the CU.

In some example embodiments, the first apparatus 210 may determine that the at least one condition of TCI state activation for the cell is not met. Based on the determining that the at least one condition of TCI state activation for the cell is not met, the first apparatus 210 determines not to transmit an indication of activation of the at least one TCI state for the cell based on the L3 measurement.

In some example embodiments, the first apparatus 210 determine, based at least in part on the L3 measurement for the cell, that at least one TCI state for the cell is not to be activated. Based on the determining that at least one TCI state for the cell is not to be activated, the first apparatus 210 may not transmit, to the second apparatus 220, an indication of activation of the at least one TCI state for the cell.

In some example embodiments, the first apparatus 210 may determine that the at least one condition of TCI state activation for the cell is met by determining the following: that the cell associated with the L3 measurement is configured in a configuration of L1 measurement for the second apparatus 220, and that a reference signal associated with at least a part of the L3 measurement is configured in the configuration of L1 measurement for the cell for the second apparatus 220. In example embodiments of the present disclosure, the first apparatus 210 may enable TCI state activation/indication based on L3 measurements during the LTM handover under specific conditions.

In some example embodiments, to enable TCI state activation/indication based on the reported L3 measurements at or before LTM cell switch under the following conditions. In a first condition, the second apparatus 220 has reported L3 measurements for a LTM candidate cell for which L1 measurements have been configured in the LTM candidate configuration. In a second condition, in the reported L3 measurement results, the reference signal (SSB or CSI-RS) that has been measured is the same reference signal that is configured for L1 measurement in the LTM candidate cell configuration for the corresponding cell/beam.

In some example embodiments, when the measurement result for an LTM candidate cell that the first apparatus 210 has available is a L3 measurement result reported in either L1 or L3 measurement report, the first apparatus 210 may check whether the RS (for example SSB or CSI-RS) that has been measured is configured for the corresponding cell/beam for L1 measurement in the LTM candidate cell configuration.

In some example embodiments, if the RS is the same for the reported L3 measurement and the configured L1 measurement, the first apparatus 210 may activate a TCI state for the cell/beam in question based on the L3 measurement. Else, the first apparatus 210 has to wait for the second apparatus 220 to send a L1 measurement report for the cell before TCI state can be activated (legacy behavior).

In some example embodiments, the first apparatus 210 may determine that the at least one condition of TCI state activation for the cell is met by further determining that the L3 measurement is received in a L1 measurement report. For example, as an optional condition, the TCI state may be activated based on L3 measurements only if the L3 measurement results are reported in the L1 measurement report (and the second apparatus 220 supports such capability). As an additional or alternative optional condition, the TCI state activation is done on FR1, FR2, or other predetermined frequency range.

In some examples, optionally, the TCI state activation may be allowed based on L3 measurements under one or both of the following conditions: L3 measurement results are reported in L1 measurement report (and the second apparatus 220 supports such capability), TCI state activation is done on FR1 or FR2.

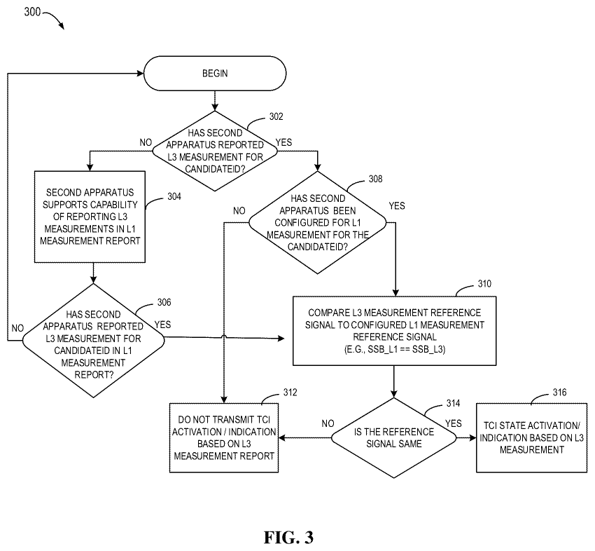

In some example embodiments, TCI activation based on L3 measurement may be done following the specified LTM procedure either before the cell switch command with a separate MAC CE or at the cell switch command. The overall procedure will be illustrated with reference to FIG. 3.

In some example embodiments, the first apparatus 210 may optimize the L1 measurements in the LTM candidate cell configuration to be for the same RS as L3 measurements configured for the second apparatus 220 for the corresponding cell/beam. In some example embodiments, the first apparatus 210 may transmit a configuration of L1 measurement for the second apparatus to the second apparatus 220, wherein the configuration of L1 measurement indicates the cell and a same reference signal as measured in the L3 measurement.

In some example embodiments, the first apparatus 210 may prepare the LTM candidate cell configuration in a way that it (always) assigns the second apparatus 220 to perform L1 measurements on the same RS as the L3 measurements configured for the second apparatus 220 either in the same LTM candidate cell configuration or in another (L3) measurement configuration. With such optimization, the first apparatus 210 may guarantee to receive either L3 or L1 measurement results suitable for TCI state activation from as many LTM candidate cells as possible.

Reference is now made to FIG. 3, which illustrates a flowchart of a process 300 of TCI state activation/indication based on L3 measurement according to some example embodiments of the present disclosure. The process 300 may be implemented at the first apparatus 210.

At block 302, the first apparatus 210 may determine whether the second apparatus 220 has reported a L3 measurement for a candidate ID, where the candidate ID may be an identify of a LTM candidate cell.

If the second apparatus 220 has reported L3 measurement, at block 308, the first apparatus 210 may determine whether the second apparatus 220 has been configured for a L1 measurement for the candidate ID.

If the second apparatus 220 has been configured for a L1 measurement for the candidate ID, at block 310, the first apparatus 210 may compare the L3 measurement reference signal to the configured L1 measurement reference signal (e.g., SSB_L1==SSB_L3). If the second apparatus 220 has not been configured for a L1 measurement for the candidate ID, at block 312, the first apparatus 210 may not transmit TCI activation/indication based on L3 measurement report.

At block 314, the first apparatus 210 may determine whether the reference signal is the same. If the reference signal is the same, at block 316 the first apparatus 210 may transmit TCI state activation/indication will be determined based on the L3 measurement. If the second apparatus 220 has been configured for a L1 measurement for the candidate ID as determined at block 308 or if the reference signal is not the same as determined at block 314, the process 300 goes to block 312, where the first apparatus 210 may not transmit TCI activation/indication based on the L3 measurement report.

Back to block 302, if the second apparatus 220 has not reported L3 measurement, at block 304, the second apparatus 220 may support capability of reporting the L3 measurements in the L1 measurement report.

At block 306, the first apparatus 210 may determine whether the second apparatus 220 has reported the L3 measurement for the candidate ID in the L1 measurement report.

If the second apparatus 220 has reported the L3 measurement for the candidate ID in the L1 measurement report, the process 300 goes to block 310, the first apparatus 210 may compare the L3 measurement the reference signal to the configured L1 measurement reference signal (e.g., SSB_L1==SSB_L3).

If the second apparatus 220 has not reported L3 measurement, the process 300 returns back to the beginning.

In some example embodiments, if the at least one TCI state is activated based on the L3 measurement, the at least one TCI state is known if at least one condition of known TCI state associated with L3 measurement is met.

In some example embodiments, the definition of known TCI state needs to be updated when TCI state is activated/indicated based on L3 measurements. Following is an example of how to define a known TCI state based on L3 measurements reported in L1 measurement report (as in Table 3) or L3 measurement report (as in Table 4). In Table 3 and Table 3, bold parts are new compared to the legacy definition. If TCI state can be activated based on either L1 or L3 report, the bold parts in both tables may be combined.

TABLE 4
8.15.2 Known conditions for downlink TCI state based on L3 measurement reported
in L1 measurement report
when a downlink TCI state is activated based on L3 measurements reported in L1
measurement report the downlink TCI state is known if the following conditions are
met:
During the period from the last transmission of the RS resource used for the L3-
RSRP measurement reporting in L1 measurement report for the target downlink
TCI state to the completion of active downlink TCI state switch, where the RS
resource for L3-RSRP measurement is the RS in target downlink TCI state or
QCLed to the target downlink TCI state.
Downlink TCI state switch command is received within 1280 ms upon
the last transmission of the RS resource for beam reporting or
measurement.
The second apparatus 220 has sent at least 1 L1-RSRP report
containing L3-RSRP measurement result for the target downlink TCI
state before the downlink TCI state switch command.
The target downlink TCI state remains detectable during the downlink
TCI state switching period.
The SSB associated with the downlink TCI state remain detectable
during the downlink TCI switching period.
SNR of the downlink TCI state ≥−3 dB.
The SSB can be associated with either the serving cell PCI or a PCI
different from serving cell PCI.
Otherwise, the downlink TCI state is unknown.

TABLE 5
8.15.2 Known conditions for downlink TCI state based on L3 measurement
When a downlink TCI state is activated based on L3 measurements the downlink
TCI state is known if the following conditions are met:
During the period from the last transmission of the RS resource used for the L3-
RSRP measurement reporting for the target downlink TCI state to the completion of
active downlink TCI state switch, where the RS resource for L3-RSRP measurement
is the RS in target downlink TCI state or QCLed to the target downlink TCI state.
Downlink TCI state switch command is received within 1280 ms upon the last
transmission of the RS resource for beam reporting or measurement.
The second apparatus 220 has sent at least 1 L3-RSRP report for the target
downlink TCI state before the downlink TCI state switch command.
The target downlink TCI state remains detectable during the downlink TCI state
switching period.
The SSB associated with the downlink TCI state remain detectable during the
downlink TCI switching period.
SNR of the downlink TCI state ≥−3 dB.
The SSB can be associated with either the serving cell PCI or a PCI
different from serving cell PCI.
Otherwise, the downlink TCI state is unknown.

In some example embodiments, the first apparatus 210 may perform an additional L1 measurement or an additional L3 measurement for the cell during the activation of the at least one TCI state before a cell switch command for the cell or at the cell switch command.

In some example embodiments, TCI state activation based on L3 measurement may require an additional L1 or L3 measurement during the TCI state activation before/at the LTM cell switch, when the TCI state is unknown.

In some example embodiments, when the TCI state is unknown based on the definition as described above (e.g., in Table 4 and/or Table 5), the second apparatus 220 may perform L1 measurement during the TCI state switch similar to legacy delay requirement (LTM in this case is not purely based on L3 measurement, but L1 measurement would only be required at the TCI state activation for a cell for which a TCI state is activated, and the second apparatus 220 would not need to perform L1 measurement before the TCI state activation, which may be before or at the cell switch command), or

In some example embodiments, when the TCI state is unknown based on the definition as described above (e.g., in Table 4 and/or Table 5), the second apparatus 220 may perform L3 measurement during the TCI state switch to make the TCI state known. In this case, L1-RSRP measurement (T_L1-RSRP) in the TCI state switching delay requirement would be changed to T_L3-RSRP, meaning one L3 measurement period. (this alternative enables LTM to be completed purely based on L3 measurements).

Both options are shown in FIG. 5 with TCI state activation before the cell switch command and FIG. 6 with TCI state activation at the cell switch command.

As shown in FIG. 5, the first apparatus 210 transmits LTM candidate cell configuration 502. The second apparatus 220 receives the configuration and performs L3 measurement. The second apparatus 220 transmits L1/L3 measurement report with L3-RSRP 504 to the first apparatus 210. The first apparatus 210 receives the report and transmits TCI state activation command 506. The second apparatus 220 receives the command and determines TCI state switching delay-unknown TCI state. During the procedure, the second apparatus 220 performs L1 measurement or L3 measurement. The first apparatus 210 further transmits LTM cell switch command with TCI state indication 508. The second apparatus 220 receives the command and performs the LTM cell switch delay/interruption.

As shown in FIG. 6, the first apparatus 210 transmits LTM candidate cell configuration 602. The second apparatus 220 receives the configuration and performs L3 measurement. The second apparatus 220 transmits L1/L3 measurement report with L3-RSRP 604 to the first apparatus 210. The first apparatus 210 receives the report and transmits LTM cell switch command with TCI state activation and indication 606. The second apparatus 220 receives the command and determines LTM cell switch delay/interruption containing the TCI state switching delay-unknown TCI state. During the procedure, the second apparatus 220 performs L1 measurement or L3 measurement.

It is noted that L1/L3 measurement is placed inside the cell switch delay. Alternatively, it can be considered that the measurement happens after the cell switch has been completed. This needs to be discussed and agreed.

In some example embodiments, the first apparatus 210 may transmit, to the second apparatus, at least one of the following: an indication indicating that the additional L1 measurement or the additional L3 measurement for the cell is to be performed during the activation of the at least one TCI state before the cell switch command or at the cell switch command, or an indication indicating that the activation of the at least one TCI state is performed based on the L3 measurement.

In some example embodiments, when TCI state is activated based on L3 measurement, the following options are possible.

In some example embodiments, one option is that the second apparatus 220 is assumed to know that the TCI state is being activated based on L3 measurement, because the second apparatus 220 has not reported L1 measurements. No additional indication is needed.

In some example embodiments, the other option is that the first apparatus 210 may indicate to the second apparatus 220 that the TCI state activation is based on L3 measurement. This may e.g., be a one bit value in the MAC-CE containing the TCI state activation command (for example: 0=“activation based on L1 measurement”, 1=“activation based on L3 measurement”).

For the alternative 1 as described above, the proposed behavior may be realized in one of the following ways.

In some example embodiments, one way is that the second apparatus 220 behavior is predefined in the standard.

In some example embodiments, another way is that the first apparatus 210 tells the second apparatus 220 whether an additional L1/L3 measurement is needed based on one or more of the proposed alternatives. This option requires network indication, which can be depending on the defined alternatives. For example, a one bit indication telling the second apparatus 220 to perform or not perform an additional measurement (L1/L3). For another example, an indication from a set of values, for example: “L1 measurement after the cell switch has been completed”, “L1 measurement during TCI state activation” and “no L1 measurement needed”.

In some example embodiments, the at least one TCI state is unknown to the second apparatus.

In some example embodiments, the first apparatus 210 may perform an additional L1 measurement for the cell during the activation of the at least one TCI state before a cell switch command for the cell or at the cell switch command, or after the cell switch command.

In some example embodiments, TCI state activation based on L3 measurement may require an additional L1 measurement always either during the TCI state activation before/at the LTM cell switch or after the cell switch has been completed, regardless of the TCI state being known or unknown.

In some example embodiments, when TCI state is activated within the LTM procedure, TCI state can be considered being known or unknown.

In some example embodiments, when a TCI state is unknown, in the legacy requirements an additional delay of one L1-RSRP measurement period is expected in TCI state switching requirements to allow Rx beam refinement in FR2, when QCL Type D is involved.

In some example embodiments, when TCI state is activated/indicated based on L3 measurements, the following options are possible.

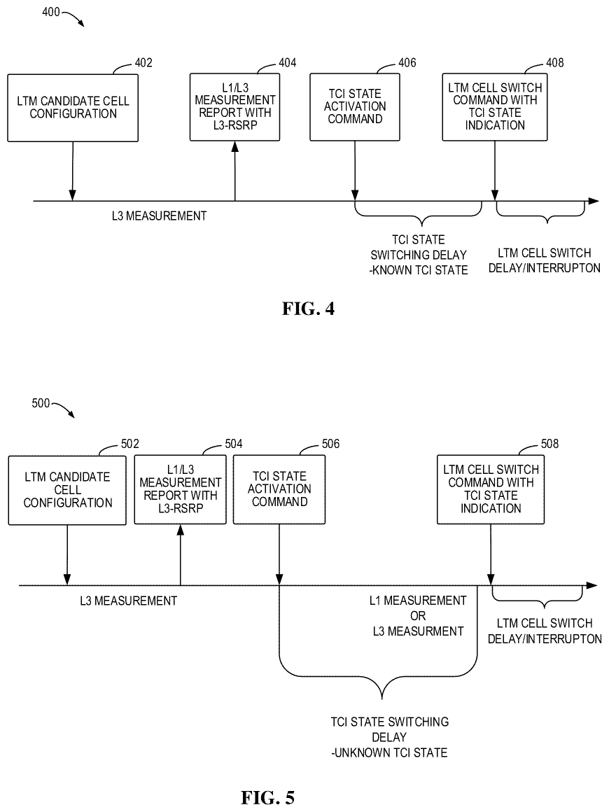

In some example embodiments, as Alternative 1, TCI state can be either known or unknown based on the definition as given above, and further measurement at the TCI state switching delay is included only if the TCI state is unknown.
When the TCI state is known based on the definition as given above, legacy TCI state switching delay can be reused and TCI state switching delay does not require further measurements. The procedure would look like shown in FIG. 4, when the TCI state activation is done before the cell switch command.

As shown in FIG. 4, the first apparatus 210 transmits LTM candidate cell configuration 402. The second apparatus 220 receives the configuration and performs L3 measurement. The second apparatus 220 transmits L1/L3 measurement report with L3-RSRP 404 to the first apparatus 210. The first apparatus 210 receives the report and transmits TCI state activation command 406. The second apparatus 220 receives the command and performs TCI state activation within a TCI state switching delay defined for a known TCI state. The first apparatus 210 further transmits LTM cell switch command with TCI state indication 408. The second apparatus 220 receives the command and performs LTM cell switch delay/interruption.

In some example embodiments, as Alternative 2a, TCI state being activated based on L3 measurement always requires the second apparatus 220 to perform L1 measurement following the TCI state activation command or LTM cell switch command with TCI state activation i.e., during the TCI state switching delay, independent of whether the TCI state is known or unknown. (This alternative does not allow LTM completion purely based on L3 measurements, but L1 measurement would only be required at the TCI state activation for a cell for which a TCI state is activated, and the second apparatus 220 would not need to perform L1 measurement before the TCI state activation, which may be before or at the cell switch command). This alternative would look similar as shown in FIGS. 5 and 6 with L1 measurement during the TCI state switching delay, when TCI state is activated before the cell switch command, or during the cell switch delay, when TCI state is activated at the cell switch command, respectively.

In some example embodiments, as Alternative 2b, TCI state being activated based on L3 measurement always requires the second apparatus 220 to perform L1 measurement, and the timing of the measurement may depend on whether the TCI state is known or unknown.

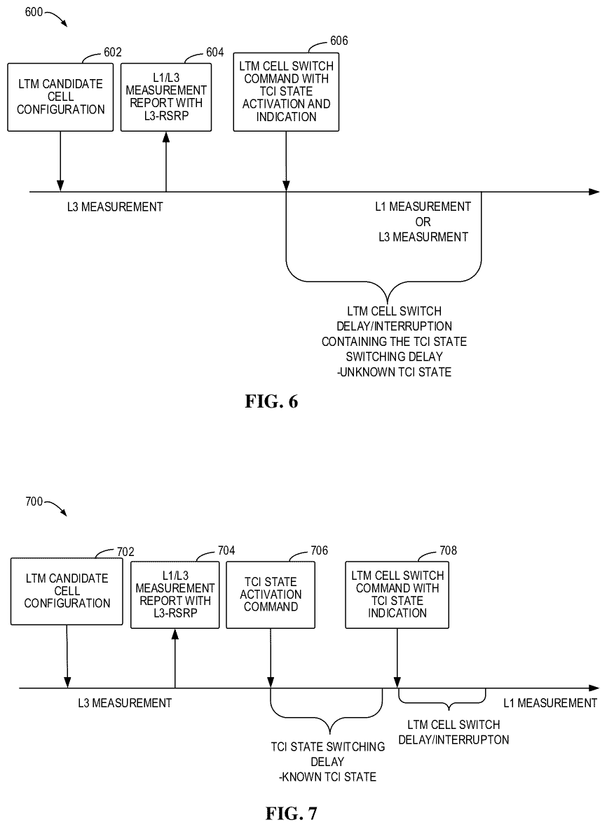

In some example embodiments, when the TCI state is known, the second apparatus 220 shall perform L1 measurement after the LTM cell switch has been completed. This option is shown in FIG. 7 for the case with TCI state activation before the cell switch command. (This alternative allows LTM completion based on L3 measurement, and L1 measurement would only happen after the cell switch has been completed).

In some example embodiments, when the TCI state is unknown, the second apparatus 220 shall perform L1 measurement following the TCI state activation command or LTM cell switch command with TCI state activation i.e., during the TCI state switching delay. This option is similar to Alternative 2a, and therefore looks as shown in FIGS. 5 and 6.

As shown in FIG. 7, the first apparatus 210 transmits LTM candidate cell configuration 702. The second apparatus 220 receives the configuration and performs L3 measurement. The second apparatus 220 transmits L1/L3 measurement report with L3-RSRP 704 to the first apparatus 210. The first apparatus 210 receives the report and transmits TCI state activation command 706. The second apparatus 220 receives the command and performs TCI state activation within a TCI state switching delay defined for a known TCI state. The first apparatus 210 further transmits LTM cell switch command with TCI state indication 708. The second apparatus 220 receives the command and performs LTM cell switch delay/interruption. Then, the second apparatus 220 performs L1 measurement.

For any of the proposed alternatives, the additional measurement delay may only be required if the TCI state switch is done on FR2, similar to legacy requirement. Alternatively, in LTM, additional measurement-based on the proposed alternatives may be required for both FR1 and FR2.

In some example embodiments, the first apparatus 210 may transmit, to the second apparatus 220, at least one of the following: an indication indicating that the additional L1 measurement is to be performed during the activation of the at least one TCI state before the cell switch command or at the cell switch command, or after the cell switch command, or an indication indicating that the activation of the at least one TCI state is performed based on the L3 measurement.

In some example embodiments, when TCI state is activated based on L3 measurement, the following options are possible.

In some example embodiments, one option is that the second apparatus 220 is assumed to know that the TCI state is being activated based on L3 measurement, because the second apparatus 220 has not reported L1 measurements. No additional indication is needed.

In some example embodiments, another option is that the first apparatus 210 may indicate to the second apparatus 220 that the TCI state activation is based on L3 measurement. This may e.g., be a one bit value in the MAC-CE containing the TCI state activation command (for example: 0=“activation based on L1 measurement”, 1=“activation based on L3 measurement”).

For the alternatives as described above, the proposed behavior may be realized in one of the following ways. In one way, the second apparatus 220 behavior is predefined in the standard. In another way, the first apparatus 210 tells the second apparatus 220 whether an additional L1 measurement is needed based on one or more of the proposed alternatives. This option requires network indication, which can be depending on the defined alternatives, for example, a one bit indication telling the second apparatus 220 to perform or not perform an additional measurement (L1). For another example, an indication from a set of values, for example: “L1 measurement after the cell switch has been completed”, “L1 measurement during TCI state activation” and “no L1 measurement needed”.

In some example embodiments, the additional L1 measurement is performed regardless of the at least one TCI state being known or unknown to the second apparatus.

In some example embodiments, as an alternative, TCI state being activated based on L3 measurement always requires the second apparatus 220 to perform L1 measurement following the TCI state activation command or LTM cell switch command with TCI state activation i.e. during the TCI state switching delay, independent of whether the TCI state is known or unknown.

According to various example embodiments of the present disclosure, the current LTM procedure with TCI state activation does not work together with L3-measurement-based cell switch decision with the current definition, because L1 measurement is currently required for the second apparatus 220 to activate a TCI state. By allowing TCI state activation/indication based on L3 measurements, LTM handover may be performed based on L3 measurements by following the current RAN1/RAN2 defined procedure with minimal or no changes to the RAN1/RAN2 specification.

According to various example embodiments of the present disclosure, enabling LTM handover based on L3 measurements makes the procedure faster in some scenarios and allows the first apparatus 210 to take into account more candidate cells when the second apparatus 220 is not capable of performing L1 measurements on all cells. This is because the first apparatus 210 would in some cases not need to wait for the second apparatus 220 to perform and report L1 measurements for the configured LTM candidate cells before the LTM cell switch decision. Furthermore, since some UEs are not capable of performing L1 measurements on more than e.g. 1 or 2 LTM candidate cells, the first apparatus 210 would need to base the LTM cell switch decision on a very limited number of cells, if it relies purely on L1 measurements. Therefore, TCI state activation/indication being a key part of LTM, it is important to allow TCI state activation based on L3 measurements.

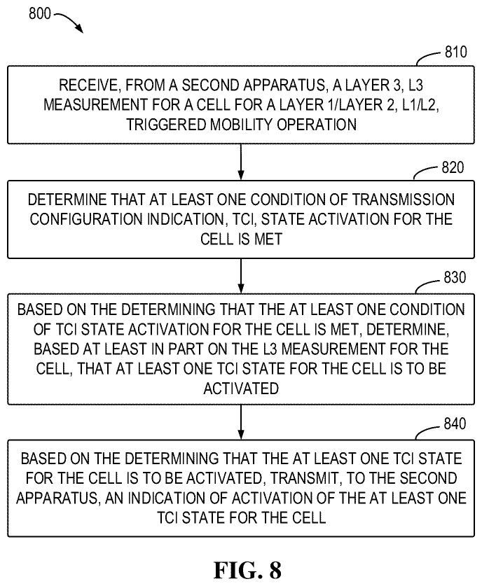

FIG. 8 shows a flowchart of an example method 800 implemented at a first device in accordance with some example embodiments of the present disclosure. For the purpose of discussion, the method 800 will be described from the perspective of the network device 110 in FIG. 1.

At block 810, the network device 110 receives, from a second apparatus, a layer 3, L3 measurement for a cell for a layer 1/layer 2, L1/L2, triggered mobility operation.

At block 820, the network device 110 determines that at least one condition of transmission configuration indicator, TCI, state activation for the cell is met.

At block 830, based on the determining that the at least one condition of TCI state activation for the cell is met, the network device 110 determines, based at least in part on the L3 measurement for the cell, that at least one TCI state for the cell is to be activated.

At block 840, based on the determining that the at least one TCI state for the cell is to be activated, the network device 110 transmits, to the second apparatus, an indication of activation of the at least one TCI state for the cell.

In some example embodiments, the method 800 further comprises: determining that the at least one condition of TCI state activation for the cell is met by determining the following: that the cell associated with the L3 measurement is configured in a configuration of LTM L1 measurement for the second apparatus, and that a reference signal associated with at least a part of the L3 measurement is configured in the configuration of LTM L1 measurement for the cell for the second apparatus.

In some example embodiments, the method 800 further comprises: determining that the at least one condition of TCI state activation for the cell is met by further determining that the L3 measurement is received in a L1 measurement report.

In some example embodiments, the method 800 further comprises: transmitting, to the second apparatus, a configuration of L1 measurement for the second apparatus, the configuration of L1 measurement indicating the cell and a same reference signal as measured in the L3 measurement.

In some example embodiments, the method 800 further comprises: performing an additional L1 measurement or an additional L3 measurement for the cell during the activation of the at least one TCI state before a cell switch command for the cell or at the cell switch command.

In some example embodiments, the method 800 further comprises: transmitting, to the second apparatus, at least one of the following: an indication indicating that the additional L1 measurement or the additional L3 measurement for the cell is to be performed during the activation of the at least one TCI state before the cell switch command or at the cell switch command, or an indication indicating that the activation of the at least one TCI state is performed based on the L3 measurement.

In some example embodiments, the at least one TCI state is unknown to the second apparatus.

In some example embodiments, the method 800 further comprises: performing an additional L1 measurement for the cell during the activation of the at least one TCI state before a cell switch command for the cell or at the cell switch command, or after the cell switch command.

In some example embodiments, the method 800 further comprises: transmitting, to the second apparatus, at least one of the following: an indication indicating that the additional L1 measurement is to be performed during the activation of the at least one TCI state before the cell switch command or at the cell switch command, or after the cell switch command, or an indication indicating that the activation of the at least one TCI state is performed based on the L3 measurement.

In some example embodiments, the additional L1 measurement is performed regardless of the at least one TCI state being known or unknown to the second apparatus.

In some example embodiments, the first apparatus comprises a network device, and the second apparatus comprises a terminal device.

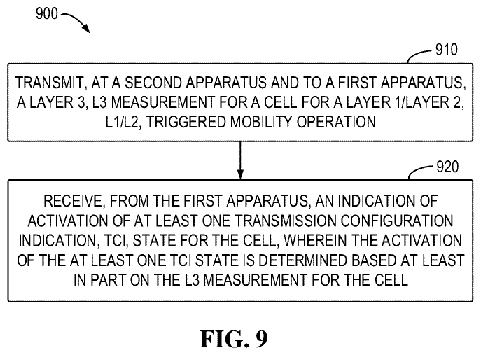

FIG. 9 shows a flowchart of an example method 900 implemented at a second device in accordance with some example embodiments of the present disclosure. For the purpose of discussion, the method 900 will be described from the perspective of the network device 110 in FIG. 1.

At block 910, the network device 110 transmits, to a first apparatus, a layer 3, L3 measurement for a cell for a layer 1/layer 2, L1/L2, triggered mobility operation; and

At block 920, the network device 110 receives, from the first apparatus, an indication of activation of at least one transmission configuration indicator, TCI, state for the cell, wherein the activation of the at least one TCI state is determined based at least in part on the L3 measurement for the cell.

In some example embodiments, the method 900 further comprises: receiving, from the first apparatus, a configuration of L1 measurement for the second apparatus, the configuration of L1 measurement indicating the cell and a same reference signal as measured in the L3 measurement.

In some example embodiments, the method 900 further comprises: performing an additional L1 measurement or an additional L3 measurement for the cell, during the activation of the at least one TCI state, before a cell switch command or at the cell switch command.

In some example embodiments, the method 900 further comprises: receiving, from the first apparatus, at least one of the following: an indication indicating that the additional L1 measurement or the additional L3 measurement for the cell is to be performed during the activation of the at least one TCI state before the cell switch command or at the cell switch command, or an indication indicating that the activation of the at least one TCI state is performed based on the L3 measurement; and determining that the additional L1 measurement or the additional L3 measurement is to be performed based on the received indication.

In some example embodiments, the at least one TCI state is unknown to the second apparatus.

In some example embodiments, the method 900 further comprises: performing an additional L1 measurement for the cell during the activation of the at least one TCI state before a cell switch command for the cell or at the cell switch command, or after the cell switch command.

In some example embodiments, the method 900 further comprises: receiving, from the first apparatus, at least one of the following: an indication indicating that the additional L1 measurement is to be performed during the activation of the at least one TCI state before the cell switch command or at the cell switch command, or after the cell switch command, or an indication indicating that the activation of the at least one TCI state is performed based on the L3 measurement; and determining that the additional L1 measurement is to be performed based on the received indication.

In some example embodiments, the additional L1 measurement is performed regardless of the at least one TCI state being known or unknown to the second apparatus.

In some example embodiments, if the at least one TCI state is activated based on the L3 measurement, the at least one TCI state is known if at least one condition of known TCI state associated with L3 measurement is met.

In some example embodiments, the first apparatus comprises a network device, and the second apparatus comprises a terminal device.

In some example embodiments, a first apparatus capable of performing any of the method 800 (for example, the network device 110 in FIG. 1 may comprise means for performing the respective operations of the method 800. The means may be implemented in any suitable form. For example, the means may be implemented in a circuitry or software module. The first apparatus may be implemented as or included in the network device 110 in FIG. 1.

In some example embodiments, the first apparatus comprises means for receiving, from a second apparatus, a layer 3, L3 measurement for a cell for a layer 1/layer 2, L1/L2, triggered mobility operation; means for determining that at least one condition of transmission configuration indicator, TCI, state activation for the cell is met; means for based on the determining that the at least one condition of TCI state activation for the cell is met, determining, based at least in part on the L3 measurement for the cell, that at least one TCI state for the cell is to be activated; and means for, based on the determining that the at least one TCI state for the cell is to be activated, transmitting, to the second apparatus, an indication of activation of the at least one TCI state for the cell.

In some example embodiments, the means for determining that the at least one condition of TCI state activation for the cell is met further comprises: means for determining that the at least one condition of TCI state activation for the cell is met by determining the following: that the cell associated with the L3 measurement is configured in a configuration of L1 measurement for the second apparatus, and that a reference signal associated with at least a part of the L3 measurement is configured in the configuration of L1 measurement for the cell for the second apparatus.

In some example embodiments, the means for determining that the at least one condition of TCI state activation for the cell is met further comprises: means for determining that the at least one condition of TCI state activation for the cell is met by further determining that the L3 measurement is received in a L1 measurement report.

In some example embodiments, the first apparatus further comprises: means for transmitting, to the second apparatus, a configuration of L1 measurement for the second apparatus, the configuration of L1 measurement indicating the cell and a same reference signal as measured in the L3 measurement.

In some example embodiments, the first apparatus further comprises: an additional L1 measurement or an additional L3 measurement for the cell during the activation of the at least one TCI state before a cell switch command for the cell or at the cell switch command.

In some example embodiments, the first apparatus further comprises: means for transmitting, to the second apparatus, at least one of the following: an indication indicating that the additional L1 measurement or the additional L3 measurement for the cell is to be performed during the activation of the at least one TCI state before the cell switch command or at the cell switch command, or an indication indicating that the activation of the at least one TCI state is performed based on the L3 measurement.

In some example embodiments, the at least one TCI state is unknown to the second apparatus.

In some example embodiments, the first apparatus further comprises: means for performing an additional L1 measurement for the cell during the activation of the at least one TCI state before a cell switch command for the cell or at the cell switch command, or after the cell switch command.

In some example embodiments, the first apparatus further comprises: means for transmitting, to the second apparatus, at least one of the following: an indication indicating that the additional L1 measurement is to be performed during the activation of the at least one TCI state before the cell switch command or at the cell switch command, or after the cell switch command, or an indication indicating that the activation of the at least one TCI state is performed based on the L3 measurement.

In some example embodiments, the additional L1 measurement is performed regardless of the at least one TCI state being known or unknown to the second apparatus.

In some example embodiments, the first apparatus comprises a network device, and the second apparatus comprises a terminal device.

In some example embodiments, the first apparatus further comprises means for performing other operations in some example embodiments of the method 800 or the network device 110. In some example embodiments, the means comprises at least one processor; and at least one memory storing instructions that, when executed by the at least one processor, cause the performance of the first apparatus.

In some example embodiments, a second apparatus capable of performing any of the method 900 (for example, the terminal device 120 in FIG. 1 may comprise means for performing the respective operations of the method 900. The means may be implemented in any suitable form. For example, the means may be implemented in a circuitry or software module. The second apparatus may be implemented as or included in the terminal device 120 in FIG. 1.

In some example embodiments, the second apparatus comprises means for transmitting, to a first apparatus, a layer 3, L3 measurement for a cell for a layer 1/layer 2, L1/L2, triggered mobility operation; and means for receiving, from the first apparatus, an indication of activation of at least one transmission configuration indicator, TCI, state for the cell, wherein the activation of the at least one TCI state is determined based at least in part on the L3 measurement for the cell.

In some example embodiments, the second apparatus further comprises: means for receiving, from the first apparatus, a configuration of L1 measurement for the second apparatus, the configuration of L1 measurement indicating the cell and a same reference signal as measured in the L3 measurement.

In some example embodiments, the second apparatus further comprises: means for performing an additional L1 measurement or an additional L3 measurement for the cell, during the activation of the at least one TCI state, before a cell switch command or at the cell switch command.

In some example embodiments, the second apparatus further comprises: means for receiving, from the first apparatus, at least one of the following: an indication indicating that the additional L1 measurement or the additional L3 measurement for the cell is to be performed during the activation of the at least one TCI state before the cell switch command or at the cell switch command, or an indication indicating that the activation of the at least one TCI state is performed based on the L3 measurement; and means for determining that the additional L1 measurement or the additional L3 measurement is to be performed based on the received indication.

In some example embodiments, the at least one TCI state is unknown to the second apparatus.

In some example embodiments, the second apparatus further comprises: means for performing an additional L1 measurement for the cell during the activation of the at least one TCI state before a cell switch command for the cell or at the cell switch command, or after the cell switch command.

In some example embodiments, the second apparatus further comprises: means for receiving, from the first apparatus, at least one of the following: an indication indicating that the additional L1 measurement is to be performed during the activation of the at least one TCI state before the cell switch command or at the cell switch command, or after the cell switch command, or an indication indicating that the activation of the at least one TCI state is performed based on the L3 measurement; and means for determining that the additional L1 measurement is to be performed based on the received indication.

In some example embodiments, the additional L1 measurement is performed regardless of the at least one TCI state being known or unknown to the second apparatus.

In some example embodiments, if the at least one TCI state is activated based on the L3 measurement, the at least one TCI state is known if at least one condition of known TCI state associated with L3 measurement is met.

In some example embodiments, the first apparatus comprises a network device, and the second apparatus comprises a terminal device.

In some example embodiments, the second apparatus further comprises means for performing other operations in some example embodiments of the method 900 or the terminal device 120. In some example embodiments, the means comprises at least one processor; and at least one memory storing instructions that, when executed by the at least one processor, cause the performance of the second apparatus.

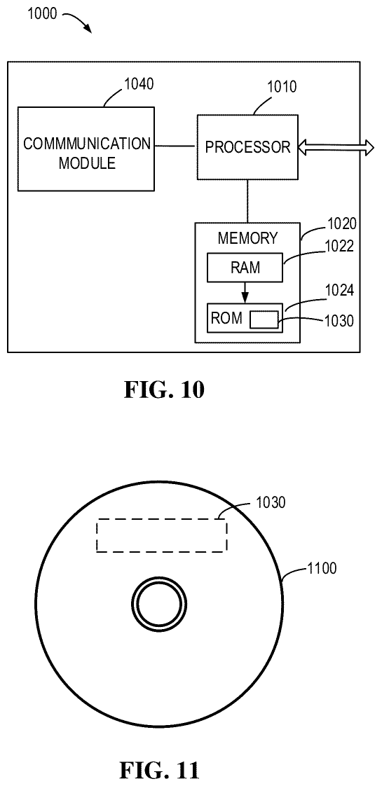

FIG. 10 is a simplified block diagram of a device 1000 that is suitable for implementing example embodiments of the present disclosure. The device 1000 may be provided to implement a communication device, for example, the network device 110 or the terminal device 120 as shown in FIG. 1, or the first apparatus 210 or the second apparatus 220 in FIG. 2. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage.

Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024.

The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

The abbreviations used herein are listed below together with their representation in unshortened form. It is noted that widely established and unique abbreviations can be assumed as known.

### List of Abbreviations

BWP Bandwidth part
CP Cyclic prefix
CSI-RS Channel State Information Reference Signal
DCI Downlink control information
DL Downlink
FR1/FR2 Frequency range 1/2
ICBM Inter-cell beam management
L1/L2/L3 Layer 1, Layer 2, Layer 3
LTM L1/L2 triggered mobility
MAC CE Medium access control control element
NR New radio
PDCCH Physical downlink control channel
PDSCH Physical downlink shared channel
PUCCH Physical uplink control channel
PUSCH Physical uplink shared channel
RSRP Reference Signals Received Power
RTD Receive timing difference
SRS Sounding reference signal
SSB Synchronization signal block
TCI Transmission configuration indicator
UE User equipment
UL Uplink

What is claimed is:

1. A first apparatus comprising:
at least one processor; and
at least one memory storing instructions that, when executed by the at least one processor, cause the first apparatus at least to perform:
receiving, from a second apparatus, a layer 3 (L3) measurement for a cell for a layer 1/layer 2 (L1/L2) triggered mobility operation;
determining that at least one condition of transmission configuration indicator (TCI) state activation for the cell is met;
based on the determining that the at least one condition of TCI state activation for the cell is met, determining, based at least in part on the L3 measurement for the cell, that at least one TCI state for the cell is to be activated; and
based on the determining that the at least one TCI state for the cell is to be activated, transmitting, to the second apparatus, an indication of activation of the at least one TCI state for the cell.

2. The first apparatus of claim 1, wherein the first apparatus is caused to perform:
determining that the at least one condition of TCI state activation for the cell is met by determining the following:
that the cell associated with the L3 measurement is configured in a configuration of L1 measurement for the second apparatus, and
that a reference signal associated with at least a part of the L3 measurement is configured in the configuration of L1 measurement for the cell for the second apparatus.

3. The first apparatus of claim 2, wherein the first apparatus is caused to perform:
determining that the at least one condition of TCI state activation for the cell is met by further determining that the L3 measurement is received in a L1 measurement report.

4. The first apparatus of claim 1, wherein the determining based at least in part on the L3 measurement for the cell comprises:
determining based at least in part on whether the first device has received from the second apparatus at least one L3 measurement result for the at least one TCI state before the indication of activation.

5. The first apparatus of claim 1, wherein the determining based at least in part on the L3 measurement for the cell comprises:
determining based at least in part on whether the indication of activation is received within 1280 ms upon the last transmission of a reference signal resource used for beam reporting of the L3 measurement.

6. The first apparatus of claim 1, wherein the first apparatus is further caused to perform:
transmitting, to the second apparatus, a configuration of L1 measurement for the second apparatus, the configuration of L1 measurement indicating the cell and a same reference signal as measured in the L3 measurement.

7. The first apparatus of claim 1, wherein the first apparatus is further caused to perform:
an additional L1 measurement or an additional L3 measurement for the cell during the activation of the at least one TCI state before a cell switch command for the cell or at the cell switch command.

8. The first apparatus of claim 7, wherein the first apparatus is further caused to perform:
transmitting, to the second apparatus, at least one of the following:
an indication indicating that the additional L1 measurement or the additional L3 measurement for the cell is to be performed during the activation of the at least one TCI state before the cell switch command or at the cell switch command, or
an indication indicating that the activation of the at least one TCI state is performed based on the L3 measurement.

9. The first apparatus of claim 1, wherein the at least one TCI state is unknown to the second apparatus.

10. The first apparatus of claim 1, wherein the first apparatus is further caused to perform:
an additional L1 measurement for the cell during the activation of the at least one TCI state before a cell switch command for the cell or at the cell switch command, or after the cell switch command.

11. The first apparatus of claim 10, wherein the first apparatus is further caused to perform:
transmitting, to the second apparatus, at least one of the following:
an indication indicating that the additional L1 measurement is to be performed during the activation of the at least one TCI state before the cell switch command or at the cell switch command, or after the cell switch command, or
an indication indicating that the activation of the at least one TCI state is performed based on the L3 measurement.

12. A second apparatus comprising:
at least one processor; and
at least one memory storing instructions that, when executed by the at least one processor, cause the second apparatus at least to perform:
transmitting, to a first apparatus, a layer 3 (L3) measurement for a cell for a layer 1/layer 2 (L1/L2) triggered mobility operation; and
receiving, from the first apparatus, an indication of activation of at least one transmission configuration indicator (TCI) state for the cell, wherein the activation of the at least one TCI state is determined based at least in part on the L3 measurement for the cell.

13. The second apparatus of claim 12, wherein the second apparatus is caused to perform:
receiving, from the first apparatus, a configuration of L1 measurement for the second apparatus, the configuration of L1 measurement indicating the cell and a same reference signal as measured in the L3 measurement.

14. The second apparatus of claim 12, wherein the determining based at least in part on the L3 measurement for the cell comprises:
determining based at least in part on whether the second apparatus has sent at least one L3 measurement result for the at least one TCI state before the indication of activation.

15. The second apparatus of claim 12, wherein the determining based at least in part on the L3 measurement for the cell comprises:
determining based at least in part on whether the indication of activation is transmitted within 1280 ms upon the last transmission of a reference signal resource used for beam reporting of the L3 measurement.

16. The second apparatus of claim 12, wherein the second apparatus is further caused to perform:
an additional L1 measurement or an additional L3 measurement for the cell, during the activation of the at least one TCI state, before a cell switch command or at the cell switch command.

17. The second apparatus of claim 16, wherein the second apparatus is further caused to perform:
receiving, from the first apparatus, at least one of the following:
an indication indicating that the additional L1 measurement or the additional L3 measurement for the cell is to be performed during the activation of the at least one TCI state before the cell switch command or at the cell switch command, or
an indication indicating that the activation of the at least one TCI state is performed based on the L3 measurement; and
determining that the additional L1 measurement or the additional L3 measurement is to be performed based on the received indication.

18. The second apparatus of claim 12, wherein the at least one TCI state is unknown to the second apparatus.

19. The apparatus of claim 12, wherein if the at least one TCI state is activated based on the L3 measurement, the at least one TCI state is known if at least one condition of known TCI state associated with L3 measurement is met.

20. A method comprising:
transmitting, at a second apparatus and to a first apparatus, a layer 3 (L3) measurement for a cell for a layer 1/layer 2 (L1/L2) triggered mobility operation; and
receiving, from the first apparatus, an indication of activation of at least one transmission configuration indicator (TCI) state for the cell, wherein the activation of the at least one TCI state is determined based at least in part on the L3 measurement for the cell.
